(19) United States
(12) Patent Application Publication
(10) Pub. No.: US 2006/0012999 A1
(43) Pub. Date: Jan. 19, 2006

(54) Molded-in light emitting diode light source

(76) Inventors: Charles M. Coushaine, Rindge, NH (US); Michael Tucker, Henniker, NH (US); Thomas Tessnow, Weare, NH (US)

Correspondence Address: William E. Meyer;Osram Sylvania Inc., 100 Endicott Street, Danvers, MA, 01923, US

(21) Appl. No.: 11/008,453

(22) Filed: Dec. 9, 2004

Related U.S. Application Data
(60) Provisional application No. 60/588,869, filed on Jul. 16, 2004.

(51) Int. Cl. F21V 29/00

(52) U.S. Cl. 362/294; 362/373

(57) ABSTRACT

A lamp assembly (10) has a base (12) with an axially extending post 14 having a first surface 16. The base and the post are thermally conductive. A light emitting diode (18) is operatively affixed to the first surface (16). A reflector (20) is in optical communication with the light emitting diode (18) and the reflector (20) is mechanically fixed to the base 12. Electrical connections (22, 24) extend through the base (12) to the light emitting diode (18).

### CROSS-REFERENCE TO RELATED APPLICATIONS

This application claims priority from Provisional Patent Application No. 60/588,869, filed Jul. 16, 2004.

### TECHNICAL FIELD

This invention relates to electric lamps and particularly to electric lamps utilizing a single light emitting diode (hereafter LED or LEDs) light source. More particularly the invention is concerned with an electric lamp with an LED light source coupled to a heat sink with rapid mounting features.

### BACKGROUND ART

In the past, most automotive light sources have involved the use of incandescent bulbs. While working well and being inexpensive, these bulbs have a relatively short life and, of course, the thin filament employed was always subject to breakage due to vibration.

Recently some of the automotive uses, particularly the stoplight, have been replaced by LEDs. These solid-state light sources have incredible life times, in the area of 100,000 hours, and are not as subject to vibration failures. However, these LED sources have been hard-wired into their appropriate location, which increases the cost of installation. Additionally, the light sources have employed multiple LEDs, which increased the cost. It would therefore be an advance in the art if an LED light source could be provided that had the ease of installation of the incandescent light sources. Alternatively, it would be advantageous to have a light source that could be permanently mounted without the need for any specific orientation.

### DISCLOSURE OF INVENTION

It is, therefore, an object of the invention to obviate the disadvantages of the prior art.

It is another object of the invention to enhance lighting operations.

These objects are accomplished, in one aspect of the invention, by a lamp assembly comprising: a base having an axially extending post with a first surface, said base being thermally conductive; a single light emitting diode operatively affixed to said first surface; a reflector in optical communication with said light emitting diode, said reflector being mechanically fixed to said thermally conductive base; and electrical connections extending through said base to said light emitting diode.

Excellent heat dissipation is provided by the direct attachment of the light emitting diode to a thermally conductive post that is an integral part of the heat-sinking base. Further, by forming the base and the reflector as a single unit, the number of parts, and thereby the necessary assembling operations, is reduced, lessening the cost of the lamp.

### BRIEF DESCRIPTION OF THE DRAWINGS

FIG. 1 is a diagrammatic view of an embodiment of the invention; and

FIG. 2 is a similar view of an alternate embodiment of the invention.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

Referring now to the drawing with greater particularity, there is shown in the figure lamp assembly 10 that comprises a base 12 having an axially extending post 14 with a first surface 16 on the distal end of the post 14. The base and integral post are thermally conductive and are preferably constructed of copper or aluminum.

A thermally conductive but electrically insulating member 19 can be affixed to the first surface 16 of the post 14 and a single light emitting diode 18 can be operatively affixed to the insulating member 19, for example by a thermally conductive cement. For optimal effect the light emitting diode is side-emitting one that is axially centered on the post 14. A reflector 20 is in optical communication with the light emitting diode 18, the reflector 20 being mechanically fixed to the base 12. In a preferred embodiment of the invention the mechanical fixation comprises the reflector 20 and the base 12 being insert-molded together. With insert molding a superb watertight seal is provided along with the more than adequate mechanical strength provided. Alternatively, the mechanical fixation can comprise the base 12 and the reflector 20 being compression-fitted together. The latter approach allows the reflector to be installed in a desired location and the light emitting diode to be inserted at a later time.

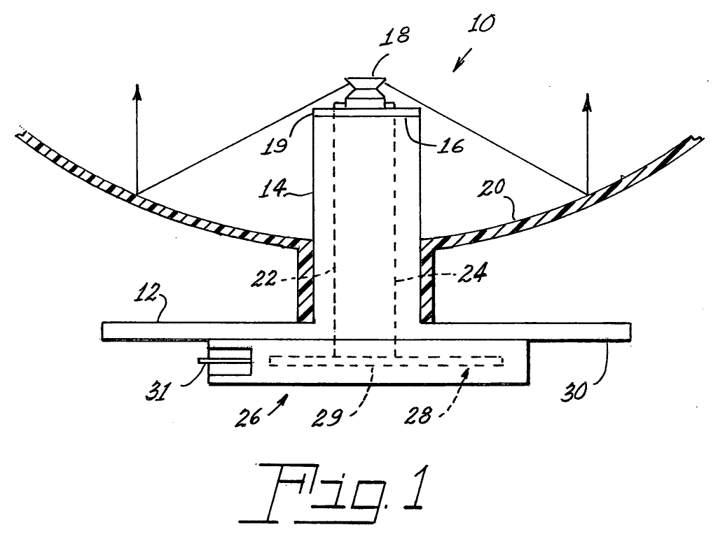

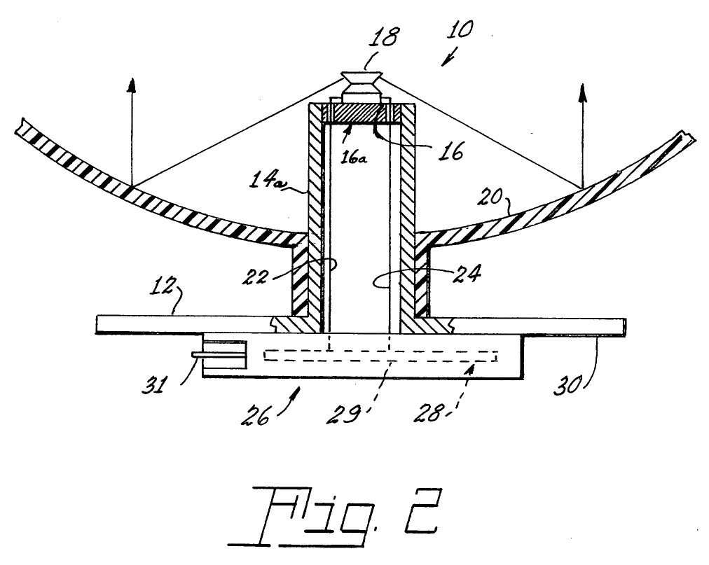

The post 14 can be solid, with passages provide for the LED connections 22, 24, as shown in FIG. 1, or it can be tubular such as post 14a, as shown in FIG. 2. In the latter embodiment the first surface 16 can be on a plug 16a fitted into the distal end of the cylindrical post 14a.

Still another alternative allows the post 16 and the base 12 to be glued into the appropriate opening in the reflector. In any case, the electrical connections 22, 24 extend through the base 12, for example, by being insulatingly threaded through the post 14, to the light emitting diode.

The electrical connections 22, 24 emanate from a housing 26 that is attached to the base 12. The housing 26 contains the necessary circuitry 28, which can be mounted on a printed circuit board 29, and a suitable connector 31 for attachment to a power source. Of course, the circuitry can be contained in other locations, as necessitated or desired by the end use of the lamp assembly.

At least one surface 30 of the base 12 is exposed to air along the exterior of the assembly 10 for heat dissipation.

In a preferred embodiment of the invention, the light emitting diode 18 is substantially a side emitting diode that is axially centered on the post 14 for maximum optical convenience. Such diodes are available on the open market.

Thus there is provided a new lamp assembly that is convenient to employ to supply various forms of automotive lighting, such as taillights, stoplights or turn signals. The assembly is virtually vibration-free and can be mounted in many ways, providing great flexibility.

While there have been shown and described what are present considered to be the preferred embodiments of the invention, it will be apparent to those skilled in the art that various changes and modifications can be made herein without departing from the scope of the invention as defined by the appended claims.

What is claimed is:

1. A lamp assembly comprising:
a base having an axially extending post with a first surface, said base being thermally conductive;
a single light emitting diode operatively affixed to said first surface;
a reflector in optical communication with said light emitting diode, said reflector being mechanically fixed to said thermally conductive base; and
electrical connections extending through said base to said light emitting diode.

2. The lamp assembly of claim 1 wherein said mechanical fixation comprises said reflector and said base being insert-molded together.

3. The lamp assembly of claim 1 wherein said mechanical fixation comprises said base and said reflector being compression-fitted together.

4. The lamp assembly of claim 1 wherein said mechanical fixation comprises said reflector and said base being glued together.

5. The lamp assembly of claim 1 wherein a housing is attached to said base and said housing includes electrical circuitry for powering said light emitting diode.

6. The lamp assembly of claim 1 wherein said base has at least one surface exposed for heat dissipation.

7. The lamp assembly of claim 1 wherein said light emitting diode is substantially a side emitting diode.

8. The lamp assembly of claim 2 wherein said light emitting diode is substantially a side emitting diode.

9. The lamp assembly of claim 3 wherein said light emitting diode is substantially a side emitting diode.

10. The lamp assembly of claim 4 wherein said light emitting diode is substantially a side emitting diode.

11. The lamp assembly of claim 5 wherein said light emitting diode is substantially a side emitting diode.

12. The lamp assembly of claim 6 wherein said light emitting diode is substantially a side emitting diode.
